(19) United States
(12) Patent Application Publication
(10) Pub. No.: US 2007/0252486 A1
(43) Pub. Date: Nov. 1, 2007

(54) MOTOR AND MANUFACTURING METHOD THEREFOR

(75) Inventor: Kazutaka Kobayashi, Nagano (JP)

Correspondence Address: CANTOR COLBURN, LLP, 55 GRIFFIN ROAD SOUTH, BLOOMFIELD, CT, 06002, US

(73) Assignee: NIDEC SANKYO CORPORATION, Nagano (JP)

(21) Appl. No.: 11/741,364

(22) Filed: Apr. 27, 2007

(30) Foreign Application Priority Data
Apr. 28, 2006 (JP) 2006-125153

(51) Int. Cl. H02K 37/14; H02K 1/22

(52) U.S. Cl. 310/49 R; 29/596; 310/261

(57) ABSTRACT

A motor may include a rotor shaft, a rotor provided with a rotor magnet, a stator, an output shaft part of the rotor shaft which may be protruded from an end portion on an output side of the stator, and a metal inertia ring which may be fixed to the output shaft part. The motor may further include a motor frame fixed on the end portion on the output side of the stator which may have a fixing plate part which may be provided with a rotor shaft through hole and which may be fixed to the end portion on the output side of the stator, a support plate part which may face the fixing plate part and which may support a tip end portion of the rotor shaft. The inertia ring may be fixed to the output shaft part between the fixing plate part and the support plate part.

### CROSS REFERENCE TO RELATED APPLICATION

The present invention claims priority under 35 U.S.C. § 119 to Japanese Application No. 2006-125153 filed Apr. 28, 2006, which is incorporated herein by reference.

### FIELD OF THE INVENTION

An embodiment of the invention may relate to a motor and a manufacturing method for the motor.

### BACKGROUND OF THE INVENTION

A stepping motor has been used in a digital camera, a digital video camera, an FDD, an ODD and the like and, when a moment of inertia of a rotor of such a motor is small, rotational irregularity and vibration may occur in the rotor. Therefore, a cylindrical inertia ring is often attached to a rotor shaft to obtain a large moment of inertia and a larger moment of inertia can be obtained as an outer diameter dimension of the inertia ring is increased.

However, when an inertia ring is attached to a portion of a rotor shaft on an inner side of a stator in a longitudinal direction, a size of the motor is increased by a portion where the inertia ring occupies. Further, when an inertia ring is arranged on the inner side of the stator, it is impossible to arrange an inertia ring having a size more than an inner diameter of the stator. Also, as a technique for preventing resonance of a rotor, a structure has been proposed in which an inertial load is fixed to a base end side in a longitudinal direction of a rotor shaft that is protruded from an opposite-to-output end portion of a stator (see, for example, Japanese Patent Laid-Open No. Hei 7-236263).

However, in the motor having a structure in which an inertia ring is fixed to a base end side in a longitudinal direction of a rotor shaft which is protruded from an opposite-to-output end portion of a stator as disclosed in the above-mentioned patent reference, an overall length of the motor becomes long. Further, when a structure is to be adopted in which a front end side of a rotor shaft is supported by a bearing and the rotor shaft is urged from a base end side of the rotor shaft with a spring to the front end side in order to prevent vibration of a rotor, there is a problem that no space can be secured to hold the spring.

### SUMMARY OF THE INVENTION

In view of the problems described above, an embodiment of the present invention may advantageously provide a motor and a manufacturing method for the motor in which a moment of inertia of a rotor shaft having an output shaft part on a front side of the rotor shaft can be increased.

Thus, according to an embodiment of the present invention, there may be provided a motor including a rotor shaft, a rotor which is provided with a rotor magnet that is fitted to the rotor shaft, a stator which faces an outer side of the rotor magnet in a radial direction, an output shaft part on a front side of the rotor shaft which is protruded from an end portion on an output side of the stator, and an inertia ring which is made of metal and which is fixed to the output shaft part.

In accordance with an embodiment of the present invention, an inertia ring which is made of metal is fixed to the output shaft part on a front side of the rotor shaft which is protruded from an end portion on an output side of the stator. Therefore, different from a case that an inertia ring is fitted to the inner side of a stator, a size of a motor can be reduced and an inertia ring having an outer diameter dimension larger than an inner diameter dimension of the stator can be fitted to the output shaft part. Further, the inertia ring is fixed to the output shaft part on the front side of the rotor shaft. Therefore, different from a structure in which the inertia ring is fixed to a base end portion of the output shaft part that is protruded from an opposite-to-output end portion of a stator, an urging member for urging the rotor shaft at a base end side of the rotor shaft to a front end side may be fixed on an end portion on the opposite-to-output side of the stator.

In accordance with an embodiment, a motor frame is fixed on the end portion on the output side of the stator. The motor frame includes a fixing plate part which is provided with a rotor shaft through hole through which the rotor shaft is penetrated and which is fixed to the end portion on the output side of the stator, a support plate part which is formed so as to face the fixing plate part and which supports a front tip end portion of the rotor shaft, and a connecting part which connects the fixing plate part with the support plate part. In this structure, the inertia ring is fixed to the output shaft part between the fixing plate part and the support plate part.

In order to manufacture the motor that is described above, it is preferable that, after the motor frame is fixed on the end portion on the output side of the stator, a front end side of the rotor shaft is passed through the inner side of the stator and the rotor shaft through hole, and then the inertia ring is fitted to the output shaft part and, after that, the inertia ring is fixed to the output shaft part. According to the motor and its manufacturing method as described above, even after the motor frame has been fixed to the end portion on the output side of the stator, the rotor can be inserted into the inner side of the stator. Further, the motor can be assembled even when an outer diameter dimension of the inertia ring is larger in comparison with an inner diameter dimension of the rotor shaft through hole and an outer diameter dimension of a rotor magnet is larger in comparison with the inner diameter dimension of the rotor shaft through hole.

In accordance with an embodiment, an outer diameter dimension of the inertia ring is larger in comparison with an outer diameter dimension of the rotor magnet. According to the structure as described above, a large moment of inertia can be obtained.

In accordance with an embodiment, the inertia ring is fixed to the output shaft part between a rotation transmission part for transmitting rotary force to the outside and the support plate part of the motor frame. According to the structure as described above, the inertia ring is not required to pass through the rotation transmission part of the output shaft part and thus, even when the rotation transmission part is formed in a large diameter, the inertia ring can be fixed to the output shaft part. Further, when the front end side of the output shaft part is formed in a small diameter, the inertia ring having a dimension of a small inner diameter can be fitted to the output shaft part. Therefore, the inertia ring having a large mass may be used although the outer diameter dimension of the inertia ring is the same and thus a large moment of inertia can be obtained. In addition, the inertia ring is not required to pass through the rotation transmission part of the output shaft part and thus the screw groove which is formed on the rotation transmission part and the like is not damaged at the time of passing the inertia ring through.

In accordance with an embodiment, the output shaft part includes a first stepped part which is formed in a tapered face, a first shaft part having a small diameter which is formed on one side of the first stepped part, and a second shaft part having a larger diameter than the first shaft part and which is formed on the other side of the first stepped part. In addition, the inertia ring is fixed to the first shaft part and an aperture edge of a center hole of the inertia ring on the second shaft part side is provided with an inclined face having a larger angle to an axial line of the motor than a tapered angle of the tapered face of the first stepped part to the axial line of the motor. According to the structure as described above, the inertia ring can be positioned by the first stepped part. Further, when the inertia ring is fitted to the first shaft part, the position in the radial direction of the inertia ring can be determined by the inclined face of the inertia ring and the tapered face of the first stepped part and thus the inertia ring can be fitted to the output shaft part in a concentric manner.

In accordance with an embodiment, the first stepped part and an aperture edge of the center hole of the inertia ring which is located on the second shaft part side are respectively formed in a conical face.

In accordance with an embodiment, the inertia ring is fixed to the output shaft part with an adhesive and a gap space for retaining the adhesive is formed between the inclined face which is formed at the aperture edge of the center hole of the inertia ring and the first stepped part of the output shaft part. According to the structure as described above, when the inertia ring is fixed to the output shaft part with the adhesive, the adhesive which is overflowed from a clearance between the inertia ring and the output shaft part does not flow to an undesired portion. Therefore, the adhesive can be prevented from sticking to the rotation transmission part.

In accordance with an embodiment, a third shaft part is provided in the output shaft part on an opposite side of the first shaft part with respect to the second shaft part and the third shaft part has an outer diameter dimension larger than an outer diameter dimension of the second shaft part and a second stepped part is formed between the third shaft part and the second shaft part. According to the structure as described above, the adhesive which is overflowed from the clearance between the inertia ring and the output shaft part is surely prevented from reaching to the third shaft part by the second stepped part. Therefore, the adhesive is surely prevented from adhering to the third shaft part.

In accordance with an embodiment, a groove for retaining the adhesive is formed on a portion of the first shaft part of the output shaft part where the inertia ring is to be fixed. According to the structure as described above, after the adhesive has been applied to the portion of the output shaft part where the groove is formed, when the adhesive is interposed between the output shaft part and the inertia ring by moving the inertia ring along the output shaft part, a sufficient amount of adhesive is held by the groove.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a half cross sectional view showing a stepping motor in accordance with an embodiment of the present invention.

FIG. 2(a) is an explanatory view showing a rotor of the stepping motor shown in FIG. 1, FIG. 2(b) is an enlarged explanatory side view showing a front end portion of the rotor, and FIG. 2(c) is a cross-sectional view showing an inertia ring.

FIGS. 3(a), 3(b) and 3(c) are explanatory views showing a manufacturing method for the stepping motor shown in FIG. 1.

### DETAILED DESCRIPTION OF THE PREFERRED EMBODIMENTS

A motor in accordance with an embodiment of the present invention will be described below with reference to the accompanying drawings.

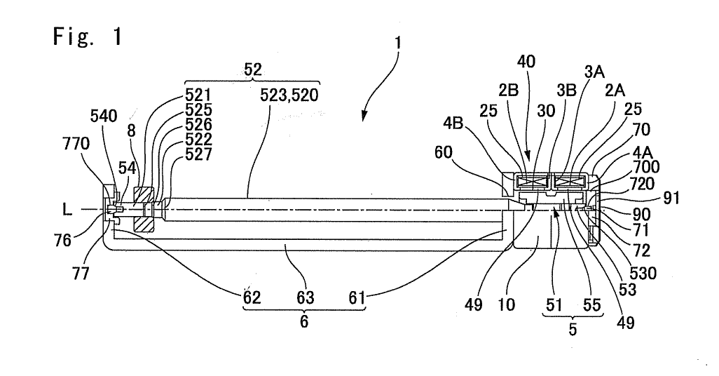

FIG. 1 is a half cross sectional view showing a stepping motor to which the present invention is applied. As shown in FIG. 1, a motor 1 in this embodiment is a small stepping motor which is used in a digital camera, a digital video camera, an FDD, an ODD or the like. The motor 1 includes a stator 40 that is provided with a first ring-shaped bobbin 2A and a second ring-shaped bobbin 2B, around which a coil 25 is wound, and which are disposed so as to be superposed in a direction of a motor axial line “L”. An inner stator core 3A and an outer stator core 4A respectively formed in a ring shape are disposed so as to be superposed on both sides of the first bobbin 2A in the direction of the motor axial line “L”. An inner stator core 3B and an outer stator core 4B respectively formed in a ring shape are disposed so as to be superposed on both sides of the second bobbin 2B in the direction of the motor axial line “L”. A plurality of pole teeth 49 of each of the inner stator cores 3A, 3B and the outer stator cores 4A, 4B is disposed in a parallel manner in a circumferential direction on inner peripheral faces of the first bobbin 2A and the second bobbin 2B. In this manner, the cylindrical stator 40 which is provided with a rotor disposing hole 30 is structured, and a base end side of a rotor 5 is disposed in an inner side of the rotor disposing hole 30 in a coaxial manner. The rotor 5 is provided with a rotor magnet 55 around the base end side of a rotor shaft 51 and the rotor magnet 55 faces the pole teeth 49 of the stator 40 in the inner side of the rotor disposing hole 30 through a specified clearance.

In this embodiment, a cylindrical case 10 is structured by outer peripheral portions of the outer stator cores 4A and 4B. The stator 40 provided with the coils 25, the inner stator cores 3A and 3B and the outer stator cores 4A and 4B, and the base end side of the rotor 5 are disposed in the inside of the case 10.

A shaft end 53 on the base end side of the rotor shaft 51 is supported by a bearing 72 through a steel ball 71. The steel ball 71 is held between a recessed part 530 having a conical recessed face formed at the shaft end 53 of the rotor shaft 51 and a recessed part 720 having a conical recessed face formed in the bearing 72. A plate-shaped bearing holder 70 which is formed of a metal sintered body is disposed at an end portion on an opposite-to-output side of the stator 40 (outer stator core 4A) so that at least a part of the bearing holder 70 overlaps with the stator 40. A bearing 72 is movably mounted on a through hole 700 of the bearing holder 70.

A pressurization apply member 90 (urging member) formed of a metal plate is disposed so that at least a part of the pressurization apply member 90 overlaps with the bearing holder 70 on an opposite-to-output side of the bearing holder 70. Four pawl parts of the pressurization apply member 90, which are extended to a side of the bearing holder 70 from its outer peripheral edge, engage with an outer peripheral edge of the bearing holder 70 to be fixed to the bearing holder 70. The pressurization apply member 90 is formed so that a flat spring part 91 is cut and bent on the bearing 72 side and the flat spring part 91 urges the bearing 72 in the through hole 80 to the rotor shaft 51 to apply pressurization to the rotor shaft 51.

A motor frame 6 is disposed on an output side of the stator 40. The motor frame 6 includes a fixing plate part 61 which is provided with a rotor shaft through hole 60 for causing the rotor shaft 51 to penetrate through and which is fixed to an end portion (outer stator core 4B) on the output side of the stator 40, a support plate part 62 which faces the fixing plate part 61 and supports a front tip end portion of the rotor shaft 51, and a connecting part 63 which connects the fixing plate part 61 with the support plate part 62. A bearing 77 is held on the support plate part 62 and a steel ball 76 is disposed between a recessed part 770 provided with a conical recessed face which is formed in the bearing 77 and a recessed part 540 provided with a conical recessed face which is formed in the shaft end 54 on the front end side of the rotor shaft 51.

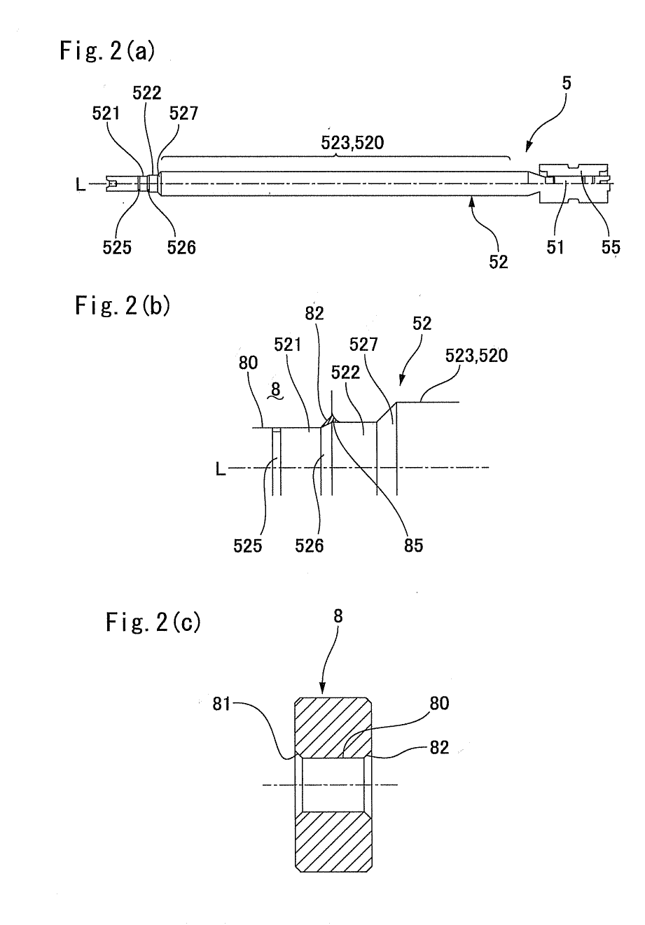

FIG. 2(a) is an explanatory view showing a rotor of the stepping motor shown in FIG. 1, FIG. 2(b) is an enlarged explanatory side view showing a front end portion of the rotor, and FIG. 2(c) is a cross-sectional view showing an inertia ring.

In the motor 1 in accordance with this embodiment, rotational irregularity and vibration occur in the rotor 5 when a moment of inertia of the rotor 5 is small. Therefore, in this embodiment, as described below, a metal inertia ring 8 is fixed to the rotor shaft 51 to increase the moment of inertia of the rotor 5.

As shown in FIG. 1 and FIGS. 2(a) and 2(b), in this embodiment, an output shaft part 52 on a front end side of the rotor shaft 51 which is protruded from an end portion on the output side of the stator 40 is formed with a rotation transmission part 520 that is provided with a screw groove for transmitting rotary force to the outside. The inertia ring 8 is fixed to the output shaft part 52 between the front end side of the rotation transmission part 520 and the shaft end 54 which is supported by the bearing 77. In this embodiment, the output shaft part 52 includes, from its front end side to its base end side, a first shaft part 521 with a small diameter, a first stepped part 526, a second shaft part 522 having a larger diameter than the diameter of the first shaft part 521, a second stepped part 527, and a third shaft part 523 having a larger diameter than the diameter of the second shaft part 522. The third shaft part 523 is the rotation transmission part 520.

An outer peripheral face of the first stepped part 526 is formed in a conical face (tapered face) and an outer peripheral face of the second stepped part 527 is also formed in a conical face (tapered face). In this embodiment, the conical faces which structure the first stepped part 526 and the second stepped part 527 are formed so that its diameter is reduced from the base end side to the front end side of the output shaft part 52. Further, a portion to which the rotor magnet 55 is fixed on the base end side of the rotor shaft 51 is provided with a slightly smaller diameter than the first shaft part 521.

In this embodiment, the inertia ring 8 is fixed to the first shaft part 521 with an adhesive and a circumferential groove 525 for retaining the adhesive is formed on the first shaft part 521.

As shown in FIG. 2(c), both end portions in an axial direction of the inertia ring 8 are formed in the same shape. Further, in a center hole 80 of the inertia ring 8 through which the output shaft part 52 is penetrated, each of an aperture edge 81 which is located on the bearing 77 side and an aperture edge 82 which is located on the second shaft part 522 side is formed with a conical face (inclined face). In this embodiment, the aperture edges 81 and 82 are formed in a conical face so that its diameter is reduced from the outer end face to its inner side. The aperture edges 81 and 82 may be formed as a usual chamfer portion.

In this embodiment, as shown in FIG. 2(b), a tapered angle which is formed between the conical face formed in the aperture edges 81 and 82 of the center hole 80 of the inertia ring 8 and the motor axial line “L” is set to be larger than a tapered angle which is formed between the conical face of the first stepped part 526 and the motor axial line “L”. Therefore, when the inertia ring 8 is fitted to the first shaft part 521, a position in a radial direction of the inertia ring 8 is controlled by mutual operation of the conical face (inclined face) which is formed on the aperture edge 82 of the inertia ring 8 and the conical face (tapered face) of the first stepped part 526 and thus the inertia ring 8 is fitted to the output shaft part 52 in a concentric manner. Further, a gap space 85 is formed based on a difference between the tapered angle of the conical face (inclined face) which is formed on the aperture edge 82 of the center hole 80 of the inertia ring 8 and the tapered angle of the conical face (tapered face) which is formed in the first stepped part 526. The gap space 85 functions as a retaining portion of an adhesive which is overflowed from a clearance between the inertia ring 8 and the output shaft part 52.

A moment of inertia occurred by the inertia ring 8 is expressed as the following expression:

J=(⅛)m(D₁²+D₂²)

=(π/32)ρL((D₁⁴+D₂⁴)

wherein:

J: moment of inertia [kg·m²]

m: mass [kg]

D₁: dimension of inner diameter [m]

D₂: dimension of outer diameter [m]

Σ: density [kg/m³]

L: length [m]

A larger moment of inertia can be obtained as a dimension of the outer diameter of the inertia ring 8 increases. Therefore, in this embodiment, the dimension of the outer diameter of the inertia ring 8 is set to be larger in comparison with a dimension of the inner diameter of the rotor shaft through hole 60 and, in addition, set to be larger in comparison with the dimension of the outer diameter of the rotor magnet 55. In this embodiment, the rotor shaft 51 is, for example, made of SUS (stainless steel) (density=7.9×10³ kg/m³), and the inertia ring 8 is, for example, made of brass (density=8.5×10³ kg/m³).

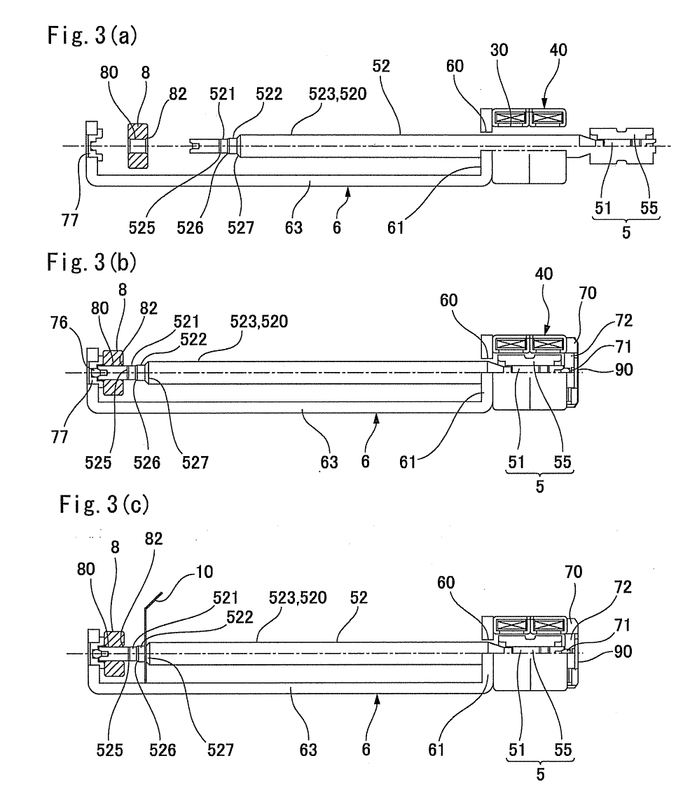

FIGS. 3(a), 3(b) and 3(c) are explanatory views showing a manufacturing method for a motor in accordance with this embodiment. In the motor 1 in this embodiment, in the case that the inertia ring 8 having the dimension of the outer diameter larger than that of the rotor shaft insertion hole 60 or the rotor magnet 55 has been attached to the output shaft part 52, when the motor 1 is to be manufactured, the rotor shaft 51 cannot be passed through the inner side of the stator 40 and the rotor shaft through hole 60 from the front end side of the rotor shaft 51. Therefore, according to this embodiment, as shown in FIG. 3(a), after the motor frame 6 has been fixed to the end portion on the output side of the stator 40, the rotor shaft 51 without the inertia ring 8 is passed through the inner side of stator 40 and the rotor shaft through hole 60 from the front end side of the rotor shaft 51. Next, as shown in FIG. 3(b), the inertia ring 8 is fitted to the output shaft part 52 and then, the front end side of the rotor shaft 51 is supported by the bearing 77 through the steel ball 76. Next, the shaft end on the base end side of the rotor shaft 51 is supported by the bearing 72 through the steel ball 71 and, in this state, the pressurization apply member 90 is attached to the bearing holder 70 to apply pressurization to the rotor shaft 51 in the front end side direction.

Next, as shown in FIG. 3(c), under a state that a partition plate 10 which is provided with a U-shaped groove is disposed at the second stepped part 527, an anaerobic UV curing type adhesive is applied to a portion of the first shaft part 521 where the circumferential groove 525 is formed. In this state, the inertia ring 8 is positioned at the front end side of the first shaft part 521. Therefore, when the inertia ring 8 is moved to the base end side of the rotor shaft 51 after the adhesive has been applied, the inertia ring 8 is moved to and positioned by the first stepped part 526. As a result, the adhesive is interposed between the center hole 80 of the inertia ring 8 and the first shaft part 521. Further, the position in the radial direction of the inertia ring 8 is determined by the conical face (inclined face) which is formed in the aperture edge 82 of the inertia ring 8 and the conical face (tapered face) of the first stepped part 526 and thus the inertia ring 8 can be fitted to the output shaft part 52 in a concentric manner. Further, the adhesive which is overflowed from the clearance between the inertia ring 8 and the first shaft part 521 is held in the gap space 85 (adhesive retaining portion) which is formed between the conical face (inclined face) of the inertia ring 8 and the conical face (tapered face) of the first stepped part 526. Further, even when a large amount of adhesive is overflowed from the clearance between the inertia ring 8 and the output shaft part 52, the adhesive is surely held by the second stepped part 527.

After that, UV (ultraviolet) light is irradiated to the adhesive to cure. As a result, the motor 1 is completed.

As described above, in the motor 1 in accordance with this embodiment, the metal inertia ring 8 is fixed to the output shaft part 52 which is protruded from the end portion on the output side of the stator 40 and on the front end side of the rotor shaft 51. Therefore, different from the case where the inertia ring 8 is arranged in the inner side of the stator 40, the size of the motor 1 can be reduced and, in addition, the inertia ring 8 having a dimension of its outer diameter larger than a dimension of an inner diameter of the stator 40 can be used. Accordingly, since a large inertia moment can be obtained, rotational irregularity and vibration of the rotor 5 can be prevented.

Further, the inertia ring 8 is fixed to the output shaft part 52 on the front end side of the rotor shaft 51. Therefore, different from a structure that the inertia ring 8 is fixed on the base end side which is protruded from the opposite-to-output end portion of the stator 40, a structure that the pressurization apply member 90 is fixed to the end portion on the opposite-to-output side of the stator 40 can be adopted.

In addition, in this embodiment, when the motor 1 is to be manufactured, after the motor frame 6 has been fixed to the end portion on the output side of the stator 40, the front end side of the rotor shaft 51 is passed through the inner side of the stator 40 and the rotor shaft through hole 60 of the frame 6 and then, the inertia ring 8 is fitted to the output shaft part 52 and, after that, the inertia ring 8 is fixed to the output shaft part 52 with an adhesive. Therefore, even after the motor frame 6 has been fixed to the end portion on the output side of the stator 40, the rotor 5 can be inserted into the inner side of the stator 40. Further, the motor 1 can be assembled even when the dimension of the outer diameter of the inertia ring 8 is larger in comparison with that of the inner diameter of the rotor shaft through hole 60 and that of the outer diameter of the rotor magnet 55.

Further, the inertia ring 8 is fixed to a front end side of the rotation transmission part 520 for transmitting a rotary force to the outside of the output shaft part 52. Therefore, the inertia ring 8 is not required to pass through the rotation transmission part 520 of the output shaft part 52 and thus the inertia ring 8 can be arranged on the output shaft part 52 even when the rotation transmission part 520 has a large outer diameter. Further, the front end side of the output shaft part 52 is formed in a small diameter and thus the inertia ring 8 having a dimension of a small inner diameter can be fitted to the front end of the output shaft part 52. Therefore, the inertia ring 8 having a large mass can be used although the outer diameter dimension is the same and thus a large moment of inertia can be obtained. In addition, the inertia ring 8 is not required to pass through the rotation transmission part 520 of output shaft part 52 and thus the screw groove which is formed on the rotation transmission part 520 and the like is not damaged when the inertia ring 8 is passed.

In addition, in this embodiment, the rotor shaft 51 is formed in a shaft with stepped parts and thus the rotor shaft 51 provides the following effects. First, the inertia ring 8 can be positioned by using the first stepped part 526. Further, the position in the radial direction of the inertia ring 8 can be determined by the conical face (inclined face) which is formed in the aperture edge 82 of the inertia ring 8 and the conical face (tapered face) of the first stepped part 526 and thus the inertia ring 8 can be fitted to the output shaft part 52 in a concentric manner. Therefore, shaking of the rotor shaft 51 and vibration of the rotor 5 can be surely prevented. In addition, the adhesive which is overflowed from the clearance between the inertia ring 8 and the first shaft part 521 is held in the gap space 85 (adhesive retaining portion) which is formed between the conical face (inclined face) of the inertia ring 8 and the conical face (tapered face) of the first stepped part 526 and thus the adhesive is not overflowed to the outside. Further, even when a large amount of adhesive is overflowed from the clearance between the inertia ring 8 and the output shaft part 52, the adhesive is surely held by the second stepped part 527. Therefore, the adhesive is surely prevented from adhering to the third shaft part 523 (rotation transmission part 520).

In addition, the circumferential groove 525 for retaining the adhesive is formed on the output shaft part 52. Therefore, after the adhesive has been applied to the portion of the output shaft part 52 where the circumferential groove 525 is formed, when the adhesive is interposed between the output shaft part 52 and the inertia ring 8 by moving the inertia ring 8 along the output shaft part 52, a sufficient amount of adhesive is held by the circumferential groove 525.

In this embodiment, the inertia ring 8 is arranged to increase an inertia moment of the rotor. However, the present invention may be applied to an application where the inertia ring 8 is used as an inertial load for damper. However, when the inertia ring 8 is used as an inertial load for damper, the inertia ring 8 is fitted through an elastic body and thus, even when it is attached to the base end side of the output shaft part 52, a screw groove formed on the rotation transmission part 520 or the like is not damaged. Therefore, this embodiment is especially effective when the inertia ring 8 is directly attached to the output shaft part 52.

In the embodiment described above, the inertia ring 8 for increasing inertia moment is attached to the front end side of the output shaft part 52 but may be attached to the base end side of the output shaft part 52. Further, the present invention may be applied to a motor other than a stepping motor.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor shaft;
a rotor which is provided with a rotor magnet fitted to the rotor shaft;
a stator which faces an outer side of the rotor magnet in a radial direction;
an output shaft part on a front side of the rotor shaft which is protruded from an end portion on an output side of the stator; and
an inertia ring which is made of metal and which is fixed to the output shaft part.

2. The motor according to claim 1, further comprising:
a motor frame which is fixed on the end portion on the output side of the stator and which comprises:
a fixing plate part which is provided with a rotor shaft through hole through which the rotor shaft is penetrated and which is fixed to the end portion on the output side of the stator;
a support plate part which is formed so as to face the fixing plate part and which supports a tip end portion of the rotor shaft; and
a connecting part which connects the fixing plate part with the support plate part;
wherein the inertia ring is fixed to the output shaft part between the fixing plate part and the support plate part.

3. The motor according to claim 2, wherein the inertia ring is fixed to the output shaft part between a rotation transmission part for transmitting rotary force to an outside and the support plate part of the motor frame.

4. The motor according to claim 1, wherein an outer diameter dimension of the inertia ring is larger in comparison with an outer diameter dimension of the rotor magnet.

5. The motor according to claim 1, wherein
the output shaft part comprises:
a first stepped part which is formed in a tapered face;
a first shaft part having a small diameter which is formed on one side of the first stepped part; and
a second shaft part having a larger diameter than the first shaft part and which is formed on the other side of the first stepped part; and
wherein the inertia ring is fixed to the first shaft part and an aperture edge of a center hole of the inertia ring on a second shaft part side is provided with an inclined face having a larger angle to an axial line of the motor than a tapered angle of the tapered face of the first stepped part to the axial line of the motor.

6. The motor according to claim 5, wherein the first stepped part and the aperture edge of the center hole of the inertia ring which is located on the second shaft part side are respectively formed in a conical face.

7. The motor according to claim 6, further comprising a gap space for retaining an adhesive which is formed between the inclined face which is formed at the aperture edge of the center hole of the inertia ring and the first stepped part of the output shaft part,
wherein the inertia ring is fixed to the first shaft part of the output shaft part with the adhesive.

8. The motor according to claim 7, further comprising:
a third shaft part which is provided in the output shaft part on an opposite side of the first shaft part with respect to the second shaft part and which has an outer diameter dimension larger than an outer diameter dimension of the second shaft part; and
a second stepped part which is formed between the third shaft part and the second shaft part.

9. The motor according to claim 7, further comprising a groove for retaining the adhesive which is formed on the first shaft part of the output shaft part.

10. The motor according to claim 1, further comprising:
an urging member for urging the rotor shaft at a base end of the rotor shaft to a front side in a motor axial line; and
a bearing which supports a front tip end portion of the output shaft part.

11. A manufacturing method for a motor comprising:
preparing a rotor which is provided with a rotor magnet fitted to a rotor shaft having an output shaft part on a front side of the rotor shaft and a stator which is to be faced an outer side of the rotor magnet in a radial direction;
preparing a motor frame which comprises:
a fixing plate part which is provided with a rotor shaft through hole through which the rotor shaft is penetrated and which is fixed to an end portion on the output side of the stator;
a support plate part which is formed so as to face the fixing plate part and which supports a tip end portion of the rotor shaft; and
a connecting part which connects the fixing plate part with the support plate part;
fixing the motor frame on an end portion on an output side of a stator;
after that, passing a front end side of the rotor shaft through an inner side of the stator and the rotor shaft through hole;
and then, fitting an inertia ring to the output shaft part; and
after that, fixing the inertia ring to the output shaft part.
